(19) United States
(12) Patent Application Publication
(10) Pub. No.: US 2025/0108668 A1
(43) Pub. Date: Apr. 3, 2025

(54) TIRE WITH ATTACHED COMPONENT AND SENSOR CONTAINER ASSEMBLY

(71) Applicant: The Goodyear Tire & Rubber Company, Akron, OH (US)

(72) Inventors: Thiago Martins Amaral, Ettelbruck (LU); Stephan Peter Hilger, Sankt Vith (BE); Thomas Salvo, Fauvillers (BE); Jean-Claude Patrice Philippe Griffoin, Mertzig (LU); Izhar Hussain, Heffingen (LU); Benoit Julien Arnaud Debout, Vinalmont (BE); Julie Martine Francoise Claudine Tahon, Reckange (LU); Christian Bock, Tawern (DE); Jason Mark Middelberg, Luxembourg (LU)

(21) Appl. No.: 18/794,254

(22) Filed: Aug. 5, 2024

Related U.S. Application Data
(60) Provisional application No. 63/586,494, filed on Sep. 29, 2023.

(51) Int. Cl. B60C 23/04; B60C 1/00

(52) U.S. Cl. CPC B60C 23/04; B60C 1/0008

(57) ABSTRACT

In one aspect, the invention is directed to a tire including an inner surface comprising an elastomer composition and partially enclosing a tire cavity. The tire further comprises a component including an attachment surface comprising a polymer composition, which is attached to a portion of the inner surface via an adhesive, wherein the attachment surface comprises a surface pattern comprising elevations including a height within a range of 20 μm to 1000 μm. In a second aspect, the invention is directed to a method of attaching a component to a portion of an inner surface of a tire. Furthermore, the invention is directed to a sensor container assembly comprising a sensor container and a tire pressure sensor.

### FIELD OF THE INVENTION

The present invention is directed to a tire comprising a component, such as a sensor container, attached to an inner surface, e.g., of an innerliner, of the tire. The invention is also directed to a sensor container, or sensor container assembly comprising a sensor container and a sensor, particularly a tire pressure sensor. Furthermore, the invention is directed to a method of attaching a component, such as a sensor container, to an inner surface of the tire.

### BACKGROUND OF THE INVENTION

Some modern tires comprise additional components, such as post-cure added components, which are attached to the tire after curing. For instance, some pneumatic tire types comprise an additional sensor which is attached to an inner surface of the tire in the tire cavity. To keep such a sensor in its position over tire life, it has to be reliably attached to the inner surface of the tire. While some methods of attaching components and/or sensors to an inner surface of the tire may be known in the art, significant room for improvement of durable attachment remains, particularly for use in high-speed applications.

### SUMMARY OF THE INVENTION

In a first aspect of the present invention, the invention is directed to a tire including an inner surface comprising an elastomer composition and partially enclosing a tire cavity, wherein the tire further comprises a component including an attachment surface comprising a polymer composition, which is attached to a portion of the inner surface via an adhesive. The attachment surface comprises a surface pattern comprising elevations including a height within a range of 20 μm to 1000 μm.

In a second aspect of the present invention, the invention is directed to a method of attaching a component to a portion of an inner surface of a tire. The method comprises steps of providing a tire comprising an inner surface partially enclosing a tire cavity; providing a component including an attachment surface comprising a polymer composition and including a surface pattern formed on the attachment surface; applying an adhesive onto one or more of the attachment surface and the portion of the inner surface; and attaching the component with its attachment surface onto the portion of the inner surface.

In a third aspect of the present invention, the invention is directed to a sensor container assembly for a tire, comprising a sensor container including an attachment surface comprising an elastomer composition, wherein the attachment surface comprises a surface pattern comprising a plurality of elevations including a height within a range of 20 μm to 1000 μm. Furthermore, the sensor container assembly comprises a tire pressure sensor carried by the sensor container.

### BRIEF DESCRIPTION OF THE DRAWINGS

The invention will be described by way of example and with reference to the accompanying drawings in which:

FIG. 1 is a schematic cross-section of a tire including a sensor container carrying a sensor in accordance with an embodiment of the present invention;

FIG. 2 is a magnified schematic cross-section of the sensor container with a mounted sensor shown already in FIG. 1;

FIG. 3 is a schematic planar view of the bottom of the sensor container shown in FIG. 2;

FIG. 4 is a schematic cross-section of another embodiment of a sensor container including triangular elevations on its attachment surface;

FIG. 5 is a schematic cross-section of yet another embodiment of a sensor container including a plurality of posts on its attachment surface;

FIG. 6 is a schematic cross-section of a comparative sensor container attached with an adhesive to a tire innerliner without elevations on its attachment surface; and

FIG. 7 is a schematic cross-section of the sensor container shown already in FIGS. 1, 2, and 3, which is attached to the innerliner, wherein spaces between elevations on the attachment surface are filled with adhesive to bond the sensor container to the innerliner.

### DETAILED DESCRIPTION OF THE INVENTION

According to said first aspect, the invention is directed to a tire including an inner surface (such as formed by an innerliner of the tire) comprising or formed by an elastomer composition, preferably a rubber composition, and partially enclosing a tire cavity. The tire further comprises a component (or, in other words, an appliance) including an attachment surface comprising or formed by a polymer composition, preferably an elastomer composition, or particularly a rubber composition, which is attached to a portion of the inner surface via or by an adhesive. The attachment surface comprises a surface pattern comprising elevations including a height within a range of 20 μm to 1000 μm, preferably within a range of 30 μm to 500 μm, or more preferably within a range of 30 μm to 200 μm, or even more preferably within a range of 50 μm and 150 μm. For instance, such a surface pattern helps to ensure that adhesive is not completely displaced from large areas of the attachment surface during mounting of the component to the inner surface. In particular, in the absence of such elevations it may happen that adhesive is unevenly distributed by being displaced in areas of the surface potentially resulting in an impaired adhesion of the component to the inner surface. Moreover, providing such a surface pattern supports a provision of a more regular adhesive layer between the inner surface and the component. In addition, the pattern increases the total surface area covered with the adhesive.

In one embodiment, preferably a majority of, the elevations comprise one or more of posts, ribs, cones, and pyramids. Optionally, posts may include various cross-sectional shapes, including but not limited to circular, elliptical, polygonal, rectangular, triangular, and other cross-sectional shapes (in a plane in parallel to the attachment surface). As another option, ribs may also be considered as elongated ribs extending along the attachment surface. Ribs may include various cross-sectional shapes, particularly in a plane perpendicular to their elongated shape, such as including rectangular shapes, triangular shapes, curved shapes, half-circular shapes, and other cross-sectional shapes. Ribs may extend over the full width of the attachment surface and/or only along portions of the attachment surface. Multiple ribs may be arranged behind one another (e.g., spaced apart from one another) in a line. Ribs may optionally extend in one or more of kinked shapes, curved shapes, undulated shapes, and zigzag shaped along the attachment surface. Pyramids may, e.g., comprise one or more of polygonal base shapes, rectangular base shapes, triangular base shapes, and other base shapes. Optionally, the term surface pattern can also be understood as surface texture.

In another embodiment, the attachment surface comprises at least 10, preferably at least 20, or even more preferably at least 50 of the elevations, or at least 100 of the elevations.

In another embodiment, a majority of the elevations are ribs extending in parallel to one another. Ribs may extend over the entire width of the attachment surface or only a portion thereof. In one embodiment a majority of the ribs extends over at least 90% of the width of the attachment surface which can be measured at the position of each rib, or along the length of each rib, respectively. Ribs can be relatively fast and/or reliably manufactured and can provide a robust basis for attaching the component to the inner surface. Moreover, neighboring, parallel ribs form a channel between them which allows flow of adhesive in parallel to the ribs along the attachment surface. Excess adhesive may exit the interface between the attachment surface and the portion of the inner surface via such channels. This helps to provide a more uniform and/or regular adhesive thickness at the interface between the component and the inner surface.

In another embodiment, the attachment surface is one or more of essentially circular, flat, and planar. In addition, or alternatively, the portion of the inner surface is one or more of essentially circular, flat, and planar.

In still another embodiment, the elevations, such as ribs, include one or more of a width (or diameter) within a range of 30 μm and 800 μm, preferably 30 μm to 600 μm, or even 50 μm to 600 μm. Such a (maximum) width of a rib is measured perpendicular to its extension. Preferably, ribs do not cross and/or contact each other. Widths and/or diameters may vary, e.g., within such ranges.

With regard to height ranges mentioned herein, it is remarked that minimum heights shall not exclude typical surface roughness. Optionally, the attachment surface and/or a portion of the inner surface may also comprise protrusions including a height smaller than 20 μm but the pattern at least includes elevations within one of the above-mentioned ranges.

In still another embodiment, the attachment surface is free of elevations including a height larger than 1000 μm, larger than 500 μm, larger than 200 μm, or larger than 150 μm.

In still another embodiment, neighboring elevations, such as ribs, include a distance within a range of 30 μm and 800 μm, preferably 30 μm to 600 μm, or 50 μm to 600 μm. The distances can vary, e.g., within such ranges. Distances, or in other words lateral distances, between neighboring elevations are measured as the shortest line between these elevations.

In still another embodiment, the (lateral) distance between a center of a top of a rib and a center of a top of a neighboring rib is within a range of 60 μm to 1600 μm, preferably within a range of 60 μm to 1200 μm, or 100 μm to 1200 μm.

In still another embodiment, said portion of the inner surface comprises another surface pattern. Such a further surface pattern may be chosen and/or dimensioned as mentioned in the embodiments herein above in relation to the surface pattern of the attachment surface. The pattern of the portion of the inner surface may be the same or different as the pattern of the attachment surface.

In still another embodiment, the pattern is a regular pattern, optionally with one or more repeating distances between neighboring elevations.

In still another embodiment, the portion of the inner surface may include an essentially circular shape and/or include an area which is at least the same as, or at least 5% larger, or even at least 20% larger than the area of the attachment surface. In particular, the portion of the inner surface may include the further surface pattern or texture. In addition, or alternatively, the attachment surface may also include a circular shape. Optionally, the circular portion of the inner surface may include a diameter which is larger than the diameter of the circular attachment portion, preferably within 1% to 20% larger. Optionally said portion is cleaned, such as laser cleaned, e.g., before forming the surface pattern on the portion of the inner surface.

In still another embodiment, space between the elevations is at least predominantly filled with the adhesive. The adhesive may be considered as a part of the tire.

In still another embodiment, the surface pattern is open along at least one direction in parallel to the attachment surface. In other words, the pattern is laterally open to at least one side. In particular, in such an embodiment, adhesive (when still in a liquid state) can flow along the attachment surface between the elevations. In particular, such elevations do not block such a flow in all directions in parallel to the surface. If the pattern is laterally closed/barred, or in other words not open in parallel to the attachment surface, adhesive may still be present within the space between the elevations but might flow and/or distribute less effectively. In addition, or alternatively, the surface pattern comprises passageways between the elevations allowing fluid flow between a first lateral side of the surface pattern and a second lateral side of the surface pattern (which is laterally opposite to the first lateral side of the surface pattern).

In still another embodiment, the tire comprises an innerliner (which can typically be described as a gas barrier layer comprising or consisting of a rubber composition, e.g., comprising butyl rubber and filler material) wherein the portion of the inner surface is a portion of a surface of the innerliner, particularly facing the tire cavity.

In still another embodiment, said component is one or more of a container; a sensor; a sensor container; a container comprising a sensor (which may also be considered as a sensor container assembly); comprising or made of an elastomer composition; comprising or made of a rubber composition; comprising or made of a sulfur-cured rubber composition, a container comprising the attachment surface. Optionally, a container could also be an RFID tag comprising the attachment surface. Optionally, a sensor can at least partially be encapsulated in the polymer composition and/or includes the attachment surface formed by the polymer composition.

In still another embodiment, the tire is one of a passenger car tire, a motorcycle tire, a truck tire, an aircraft tire, an agricultural, a racing tire (e.g., one of a slick tire and a semi-slick tire), and an off-the-road tire.

In still another embodiment, said adhesive is selected from one or more of a cyano-acrylate adhesive, a solvent based adhesive, an epoxy adhesive, an isocyanate adhesive, a silicone adhesive, a polyurethane adhesive, and a pressure sensitive adhesive. An adhesive may also be applied in multiple layers, such as by means of a double-sided adhesive tape. The use of an adhesive tape is also covered by the terms attached via, with or by an adhesive, or applying an adhesive.

In yet another embodiment, the tire is a pneumatic tire, preferably a pneumatic passenger car or truck tire.

In still another embodiment, an elastomer composition (such as a rubber composition) comprises one or more of one or more rubbers (such as comprising one or more of natural rubber, synthetic polyisoprene, butadiene rubber, styrene-butadiene rubber, butyl rubber), a filler (such as comprising one or more of carbon black and silica), one or more resins (such as one or more hydrocarbon resins comprising one or more of coumarone-indene resin, petroleum hydrocarbon resin, terpene resin, styrene/alphamethylstyrene resin, terpene phenol resin, rosin derived resin and copolymers and/or mixtures thereof), one or more accelerators, one or more antidegradants, one or more oils, one or more liquid diene based polymers, one or more coupling agents (such as carbon black coupling agents and/or silanes), one or more sulfur donors, and sulfur or one or more sulfur compositions. The composition may be a sulfur-curable or sulfur cured rubber composition. For instance, the inner surface and/or the attachment surface may comprise, be formed of, and/or consist of such a composition. Optionally, the container comprises and/or consists of such a composition. Optionally, elastomer compositions, such as rubber compositions may be cord and/or fiber reinforced.

In still another embodiment, an elastomer composition comprises and/or is based on a thermoplastic elastomer, such as a thermoplastic polyester elastomer. Optionally, one or more of the attachment surface, the component, the container, and the sensor container comprise, is formed of, or consists of such a composition.

In still another embodiment, a polymer composition is chosen from an elastomer composition (e.g., as mentioned herein above) and a polyurethane based composition.

In the second aspect, the invention is directed to a method of attaching a component (or, in other words, an appliance) to a portion of an inner surface of a tire. For instance, the tire may be the tire in accordance with the first aspect and/or one or more of its embodiments, or other embodiments disclosed herein. The method comprises steps of:
Providing a tire, preferably a cured tire, comprising an inner surface such as the surface of a, preferably cured, innerliner, at least partially enclosing a tire cavity;
Providing a component, such as a container or sensor, including an attachment surface comprising a polymer composition and including a surface pattern formed on the attachment surface;
Applying an adhesive onto one or more of the attachment surface and the portion of the inner surface; and
Attaching the component with its attachment surface onto the portion of the inner surface.

In one embodiment, the step of providing a tire comprises providing a cured tire.

In another embodiment, the method further comprises the step of forming or manufacturing the surface pattern on the attachment surface by one or more of molding (such as injection molding), additive manufacturing (such as one or more of 3D-printing, chemical deposition, and vapor deposition; wherein added material is preferably the same as the material of the attachment surface), subtractive manufacturing (such as one or more of laser engraving, chemical removal, e.g., etching, and abrasive, mechanical techniques). Said additive and/or subtractive manufacturing is also preferred when providing a surface pattern on the portion of the inner surface of the tire. Laser engraving or ablation is particularly preferred.

In still another embodiment, the component is a container comprising the elastomer composition, preferably a rubber composition, wherein the surface pattern is optionally formed when molding the container. Alternatively, the attachment surface may be part of a layer attached and/or bonded to such a container. The layer may be molded, including the surface pattern.

In still another embodiment, the surface pattern is formed by subtractive manufacturing, which is a preferred method herein.

In still another embodiment, the surface pattern is formed by laser engraving/ablation.

In still another embodiment, the method further comprises the step of cleaning one or more of the attachment surface and the portion of the inner surface before attaching the component. Preferably, such a cleaning step involves laser cleaning. Preferably, the cleaning step is carried out before the step of forming the surface pattern on the respective surface. Other cleaning options include, e.g., solvent cleaning. In another option, a removable foil is provided on the inner surface (e.g., the innerliner's surface) before curing the tire and which can be peeled after curing to provide a relatively clean surface.

In still another embodiment, the component is a sensor container and the method optionally further comprises the step of mounting the sensor in the sensor container. Preferably, the sensor container is attached with its attachment surface onto the portion of the inner surface together with the mounted sensor. In other words, the sensor is optionally mounted in a first step into the sensor container and the sensor container is attached to the portion of the inner surface with the mounted sensor in a second step. Optionally, the sensor container is applied onto the inner surface by a robotic device, e.g., pushing the sensor container essentially perpendicularly onto the portion of the inner surface. Preferably, the sensor is in a lateral center area or portion of the sensor container and, optionally, the robotic device pushes onto the sensor container in an area laterally besides, optionally concentrically around, the sensor so as to attach the sensor container to the portion of the inner surface.

In still another embodiment, the surface pattern comprises elevations comprising one or more of: a height within a range of 20 μm to 1000 μm; and one or more of posts, ribs, and pyramids. It is noted that very high elevations (measured perpendicular to a plane of the attachment surface) are less desirable as adhesive collected between these elevations may be too thick, which may result in a high consumption of adhesive and/or might even impair the bonding strength as very thick adhesive layers, such as based on cyano-acrylate adhesive may tend to be brittle. Very small elevations may also be less desirable as the adhesive layer collected between the elevations may be very thin and/or the ability of the adhesive to flow parallel to the attachment surface may be limited.

In still another embodiment, the portion of the inner surface comprises another surface pattern comprising elevations comprising one or more of: a height within a range of 20 μm to 500 μm; and one or more of posts, ribs, cones, and pyramids. With regard to the portion of the inner surface, elevations with larger height may also be less desirable, particularly when obtained with a subtractive method. Exaggerated removal of material at the inner surface (e.g., innerliner material) may impair the air barrier properties of the tire's inner surface.

According to the third aspect, the invention is directed to a sensor container assembly for a tire. The assembly comprises i) a sensor container including an attachment surface comprising and/or consisting of an elastomer composition (such as a rubber composition), wherein the attachment surface comprises a surface pattern comprising a plurality of elevations including a height within a range of 20 μm to 1000 μm. Furthermore, the sensor container comprises a tire pressure sensor carried by the sensor container.

In one embodiment, the sensor container comprises a hollow space for receiving and/or carrying the sensor.

In another embodiment, said space is one of an essentially hollow cylindrical space, and a frustoconical space.

In still another embodiment, said space is laterally in a center of the sensor container.

In another embodiment, the sensor includes a flange portion for holding the sensor in position, such as in said space and/or via a form fit.

In still another embodiment, the sensor is removable or separatable from the container by deformation of the, preferably flexible, flange portion. Preferably, the flange portion is made of an elastomer composition, preferably a rubber composition.

In still another embodiment, the pressure sensor is adapted to measure pressure and optionally one or more of temperature, and acceleration.

In still another embodiment, the pressure sensor may involve an energy source (e.g., one or more of a battery, an energy harvesting device, and an electromagnetic energy receiver), a processor, and a memory.

In still another embodiment, the sensor container includes a bottom portion including the attachment surface, and wherein said space is optionally provided opposite to the attachment surface. Optionally, the bottom portion supports the sensor, such as a bottom of the sensor.

In still another embodiment, the attachment surface includes one of a circular shape and an elliptical shape.

In still another embodiment, the sensor container is an RFID tag.

In a fourth aspect, the present invention is directed to a sensor container comprising or consisting of an elastomer composition comprising a bottom portion with an attachment surface to be attached to an inner surface of a tire. The attachment surface comprises a plurality of elevations including a height within a range of 20 μm to 1000 μm. Moreover, the sensor container comprises one or more of an essentially hollow cylindrical space, and a frustoconical space for receiving a cylindrically shaped sensor, such as a cylindrically shaped tire pressure sensor. Optionally, said space comprises an, e.g., flexible, flange portion at a top portion of the sensor container which is opposite to the bottom portion of the container and/or opposite to the attachment surface. Preferably, the bottom portion supports a bottom of the sensor.

It is emphasized that the features and/or embodiments of the above aspects may be combined with one another. The same applies to the features and/or embodiments mentioned herein below.

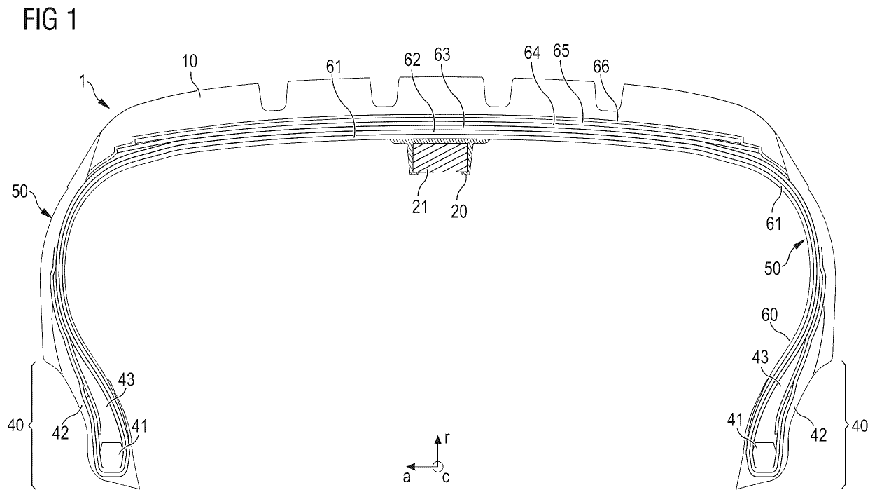

FIG. 1 shows a schematic cross-section of a tire 1 in accordance with an embodiment of the present invention. The tire 1 comprises a tread portion 10, two sidewalls 50, and two bead portions 40 each comprising a bead 41, an apex 43 and a chafer 42. Furthermore, the tire 1 comprises an innerliner 61 forming an inner surface 60 of the tire 1 and partially enclosing the tire cavity. The tire 1 also comprises two carcass plies 62, 63 which are folded around each bead 41, as well as two belt plies 64, 65, and an overlay 66 covering the belt plies 64, 65.

In accordance with the present embodiment, the inner surface 60 of the tire 1, or of the innerliner 61 respectively, carries radially below the tread portion 10 and/or the belt plies 64, 65 a sensor container 20 which partially encloses and/or carries a sensor 21. Such a sensor 21 could, e.g., be or comprise a tire pressure sensor. The sensor container 20 is preferably made of a rubber composition which is attached to or adhered to the innerliner 61 via its attachment surface by an adhesive, such as a cyano-acrylate adhesive. The sensor container 20 and the sensor 21 may be considered together as a sensor container assembly.

The radial direction r, the circumferential direction c and the axial direction a are indicated in FIG. 1 for the sake of better comprehensibility. The axial direction is in parallel with the axis of rotation of the tire. The circumferential direction c is in parallel to the circumference of the tire and perpendicular to the axial direction a. The radial direction r is also perpendicular to the axial direction and the circumferential direction. It is emphasized that a reference to one of these directions does not necessarily limit those to a certain orientation, unless indicated otherwise herein.

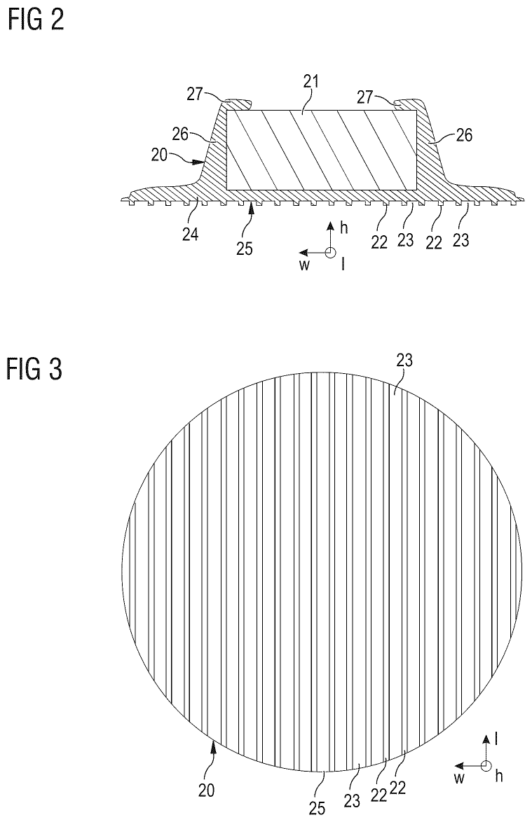

A magnified cross-section of the sensor container 20 and the sensor 21 is schematically shown in FIG. 2 in further detail. The sensor 21 is at least partially enclosed and/or carried by the sensor container 20. The sensor container 20 includes a bottom portion 24, an essentially hollow cylindrical or frustoconical sensor holding portion 26, and a circular flange portion 27 to hold the sensor 21 (which may, e.g., include an essentially cylindrical shape) in the sensor container 20. The bottom portion 24 further comprises an attachment surface 25 (on a side opposite to and/or facing away from the sensor 21) for attaching the sensor container 20 to the inner surface of a pneumatic tire (i.e., within the tire cavity). The attachment surface 25 of the sensor container 20 is schematically shown with elevations, herein ribs 22, which protrude out of the surface to be attached to the inner surface of the tire 1. The depicted elevations, here in the form of ribs 22, include an essentially rectangular cross-section perpendicular to their length/elongation. The width of these ribs 22 extends in the direction w, their elongated length in direction 1, and their height extends in the indicated direction h, which is perpendicular to the plane of the attachment surface 25. Spaces provided laterally between the ribs 22 are shown herein by reference numeral 23. It is noted that the number, size and distance of ribs 22 is rather schematically indicated in FIG. 2. Typically, a width of such ribs is within a range of 30 μm to 800 μm, such as in one example 100 μm. Neighboring ribs may, e.g., include a distance within a range of 30 μm to 800 μm, such as 400 μm in one example. The height of ribs can be within a range of 30 μm to 500 μm, such as 70 μm in a preferred example. In case of posts, those may, e.g., include widths and lengths in a similar order, such as within a range of 30 μm to 800 μm.

FIG. 3 shows a planar view of the same sensor container 20 as already shown in FIG. 2. In particular, the bottom of the sensor container 20 is shown, or in other words, its attachment surface 25, including a plurality of the ribs 22 and spaces 23 (or in other words channels) between such neighboring ribs 22. In this case, the attachment surface 25 of the sensor container 20 includes a circular cross-section. Other shapes would be possible. However, curved shapes are preferred (e.g., curved attachment surfaces) as those reduce the risk of detachment at corners. The (maximum) diameter of a sensor container is preferably less than 60 mm. In a preferred embodiment, the attachment surface 25 includes a diameter of 42 mm, or a diameter within the range of 40 mm to 45 mm.

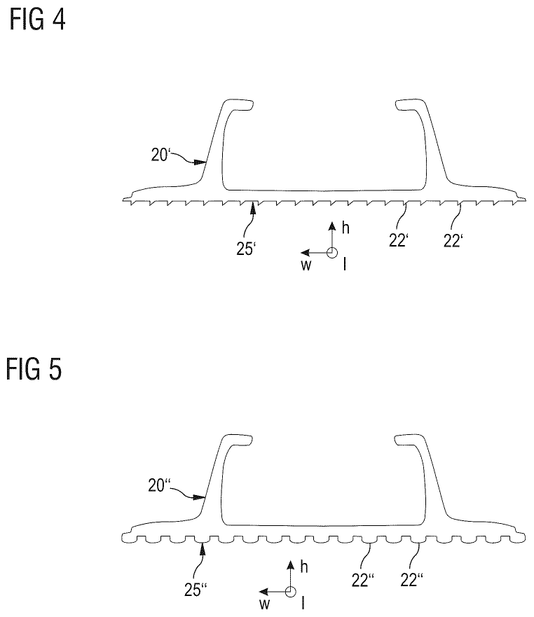

FIG. 4 shows another schematic cross-section of a sensor container 20′, in accordance with another embodiment of the present invention. In particular, the sensor container 20′ comprises an attachment surface 25′ including prism-shaped ribs 22′. The ribs 22′ include an elongated shape extending in the direction 1.

FIG. 5 depicts yet another sensor container 22″ in accordance with yet another embodiment of the present invention, which comprises a plurality of circular posts 22″ protruding out of the attachment surface 25″. The posts 22″ include at their distal end (facing the inner surface) a curved shape. In another example, it could essentially be a hemispherical shape. In the depicted embodiment, the attachment surface 25″ does not comprise ribs but a plurality of circular post, e.g., being regularly distributed over the attachment surface 25″ in directions w and 1.

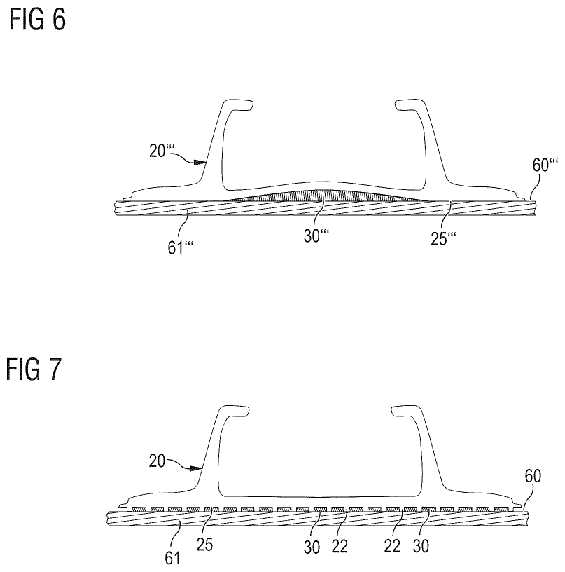

FIGS. 6 and 7 compare a sensor container without elevations in accordance with the present invention (i.e., as shown in FIG. 6) and a sensor container with elevations in accordance with an embodiment of the present invention (i.e., as shown in FIG. 7). With respect to FIG. 6, sensor container 20′″ (not in accordance with the present invention), is attached via the adhesive 30′″ applied to its attachment surface 25′″ to an innerliner 61′″. The lateral distribution of the adhesive 30′″ is irregular along the surface. While a center area of the attachment surface 25′″ includes a relatively large thickness of adhesive material, laterally outer edges of the attachment surface 25′″ include almost no or no adhesive. Such an exemplary uneven distribution of adhesive impairs an optimum bonding of the container 20′″ to the innerliner 61′″. Moreover, a too thick adhesive zone such as in a center portion of the attachment surface 25″ may result in a volume of brittle adhesive which further impairs durability. For instance, the depicted distribution of adhesive may appear if a sensor is already mounted to the container during its attachment, wherein physical pressure onto a sensor is to be avoided so that a circumferential bottom portion of the container 20′″ is pushed onto the inner surface 60′″ of the innerliner 61′″.

In contrast to the situation shown in FIG. 6, the attachment situation shown in FIG. 7, which is in accordance with an embodiment of the present invention and shows the sensor container 20 already shown in FIGS. 1, 2, and 3, is considerably improved. In particular, the elevations 22 (here in the form of ribs 22) allow a regular and/or controlled distribution of the adhesive 30 on the attachment surface 25. Excess adhesive can flow along and between neighboring elevations or ribs 22 and be discharged. The total contact area for the adhesive at the interface is increased. Moreover, too thick adhesive layers can be avoided more easily. The bond to the inner surface 60 of the innerliner 61 is improved.

The inventors have also carried out comparative tests with sensor containers as shown in FIG. 6 and in FIG. 7, i.e., mounted to an innerliner radially below the tread below the centerline of the tread. The corresponding tires were run in high-speed tests with velocities between 250 km/h and 300 km/h. In these tests, it has been observed that a container including a patterned, particularly ribbed, surface as shown in FIG. 7 provided good adhesion until more than 300 km/h, whereas the comparative example without elevations on its surface adhered only until about 290 km/h.

Sensor containers have been mentioned herein as preferred examples of components attached to an inner surface of the tire. It is emphasized that other components could be attached as well.

In summary, the present invention and/or its embodiments, provide an advanced way of reliably and/or durably attaching components, such as sensor containers or sensors, to an inner surface of a tire. The thickness of an adhesive layer between the inner surface and the attached component can be better controlled. In particular, too thick adhesive portions can be reduced and an even distribution of adhesive material is facilitated. Furthermore, a minimum thickness of adhesive can be provided along the attachment surface more easily, and the contact surface between the inner surface and the container is increased. The same applies to the bonding strength between the inner surface of the tire and the attachment surface.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire including an inner surface comprising an elastomer composition and partially enclosing a tire cavity, wherein the tire further comprises a component including an attachment surface comprising a polymer composition, which is attached to a portion of the inner surface via an adhesive, and wherein the attachment surface comprises a surface pattern comprising elevations including a height within a range of 20 μm to 1000 μm.

2. The tire according to claim 1, wherein a majority of the elevations comprises one or more of posts, ribs, cones, and pyramids.

3. The tire according to claim 1, wherein a majority of the elevations are ribs extending in parallel to one another.

4. The tire according to claim 3, wherein the ribs include a width within a range of 30 μm to 800 μm.

5. The tire according claim 3, wherein neighboring ribs include a distance within a range of 30 μm to 800 μm.

6. The tire according to claim 3, wherein the portion of the inner surface comprises another surface pattern comprising one or more of posts, ribs, cones, and pyramids.

7. The tire according to claim 1, wherein a space between neighboring elevations is at least predominantly filled with the adhesive.

8. The tire according to claim 1, wherein the surface pattern is open along at least one direction in parallel to the attachment surface.

9. The tire according to claim 1, wherein the tire comprises an innerliner and wherein the portion of the inner surface is a portion of a surface of the innerliner.

10. The tire according to claim 1, wherein said component is one or more of:
a sensor;
a container;
a container comprising a sensor;
comprising an elastomer composition;
comprising a sulfur-cured rubber composition,
a container comprising the attachment surface including a maximum diameter within a range of 10 mm to 60 mm.

11. A method of attaching a component to a portion of an inner surface of a tire, comprising the steps of:
providing a tire comprising an inner surface partially enclosing a tire cavity;
providing a component including an attachment surface comprising a polymer composition and including a surface pattern formed on the attachment surface;
applying an adhesive onto one or more of the attachment surface and the portion of the inner surface; and
attaching the component with its attachment surface onto the portion of the inner surface.

12. The method according to claim 11, wherein the step of providing a tire comprises providing a cured tire.

13. The method according to claim 11, wherein the step of providing a component including an attachment surface further comprises forming the surface pattern on the attachment surface by one or more of molding, additive manufacturing, and subtractive manufacturing, so as to obtain the surface pattern formed on the attachment surface.

14. The method according to claim 13, wherein the component is a container comprising the elastomer composition, and wherein the surface pattern is formed when molding the container.

15. The method according to claim 13, wherein the surface pattern is formed by subtractive manufacturing.

16. The method according to claim 15, wherein the surface pattern is formed by laser ablation.

17. The method according to claim 11, wherein the method further comprises the step of laser cleaning one or more of the attachment surface and the portion of the inner surface before attaching the component.

18. The method according to claim 11, wherein the component is a sensor container, wherein the method further comprises the step of mounting a sensor in the sensor container, and wherein the sensor container is attached with the attachment surface onto the portion of the inner surface together with the sensor mounted in the sensor container.

19. The method according to claim 11,
wherein the surface pattern comprises elevations comprising one or more of i) a height within a range of 20 μm to 1000 μm, and ii) one or more of posts, ribs, and pyramids; and
wherein the portion of the inner surface optionally comprises another surface pattern comprising elevations comprising one or more of A) a height within a range of 20 μm to 500 μm, and B) one or more of posts, ribs, cones, and pyramids.

20. A sensor container assembly for a tire comprising:
a sensor container including an attachment surface comprising an elastomer composition, wherein the attachment surface comprises a surface pattern comprising a plurality of elevations including a height within a range of 20 μm to 1000 μm; and
a tire pressure sensor carried by the sensor container.
